(19) United States
(12) Patent Application Publication
(10) Pub. No.: US 2006/0112147 A1
(43) Pub. Date: May 25, 2006

(54) Document management apparatus, document management method, and document management program

(75) Inventors: Yoshiko Suenaga, Kanagawa-ken (JP); Hiroki Miyachi, Kanagawa-ken (JP); Kouichi Mase, Chiba-ken (JP); Harunobu Maeda, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/264,229

(22) Filed: Oct. 31, 2005

(30) Foreign Application Priority Data
Nov. 25, 2004 (JP) 2004-340686

(51) Int. Cl. G06F 17/30

(52) U.S. Cl. 707/200

(57) ABSTRACT

A document management apparatus, a document management method, and a document management program which can set an error-coping process provided by a method simpler than a conventional method. According to the invention, a document management apparatus having a processing executing section which executes a processing to document data registered in a folder in accordance with a document processing constituted by one processing step or a plurality of processing steps allocated to the folder in advance includes an error-coping process storing section which stores a plurality of error-coping processes formed in advance, an error-coping process setting section which presents list information of the plurality of error-coping processes and sets a selected error-coping process in a folder, and an error-coping process executing section which executes the error-coping process in the folder set by the error-coping process setting section when an error occurs in the execution of the document processing by the processing executing section.

### BACKGROUND OF THE INVENTION

1. Field of the Invention

The present invention relates to a document management apparatus, a document management method, and a document management program and can be applied to, for example, a document management system having a process executing function which automatically executes a predetermined processing to a document data file to be managed.

2. Description of the Related Art

A conventional document management system which can be connected to a network and classifies designated documents in folders to manage the documents is known. In such a document management system, in order to obtain convenience of a user, a system which automatically executes various processes to a document in a folder is used (see Japanese Patent Application Laid-Open (JP-A) Nos. 2002-230010 and 7-44535).

JP-A No. 2002-230010 discloses a technique which classifies a classified document in another folder without changing document contents (including an extension). JP-A No. 2002-230010 also discloses a system which converts attribute information based on a conversion rule of attribute information between an unchanged document and a changed document and which moves or copies the changed document to another folder.

JP-A No. 7-44535 discloses a system which allocates an operation sheet formed by a plurality of users in advance to a document and sequentially executes procedures to the document according to the operation sheet.

As a document management system including an image forming apparatus (for example, a printer or the like) and an image input apparatus (for example, an OCR or the like), a system which allocates document processing constituted by one processing step or a plurality of processing steps formed in advance to a folder and causes a document management apparatus to automatically execute the document processing to a document in the folder.

In the conventional technique which executes a conventional document processing, in many cases, a predetermined error processing is executed to a document processing in which some error occurs when error setting is easy to cope with the error. Detailed designations cannot be performed for the respective processing steps.

On the other hand, when an error processing is set in each processing step, a method of defining a document processing by a script is used as a conventional technique. In this manner, an error processing can be executed for each processing step.

However, a skill in program is frequently required to define an error processing for each processing step by a script. Therefore, a general user cannot easily set the error processing.

### SUMMARY OF THE INVENTION

The present invention provides a document management apparatus, a document management method, and a document management program which can relatively easily set an error processing for one processing step constituting a document processing or respectively set error processings in a plurality of processing steps constituting a document processing.

The document management apparatus according to the present invention having processing executing section which executes a processing to document data registered in a folder in accordance with a document processing constituted by one processing step or a plurality of processing steps allocated to the folder in advance, includes: error-coping process storing section which stores a plurality of error-coping processes formed in advance; error-coping process setting section which presents list information of the plurality of error-coping processes and sets a selected error-coping process in a folder; and error-coping process executing section which executes the error-coping process in the folder set by the error-coping process setting section when an error occurs in the execution of the document processing by the processing executing section.

The present invention provides a document management method having processing executing section which executes a processing to document data registered in a folder in accordance with a document processing constituted by one processing step or a plurality of processing steps allocated to the folder in advance, wherein error-coping process storing section stores a plurality of error-coping processes formed in advance, error-coping process setting section presents list information of the plurality of error-coping processes and sets a selected error-coping process in a folder, and error-coping process executing section executes the error-coping process in the folder set by the error-coping process setting section when an error occurs in the execution of the document processing by the processing executing section.

The present invention provides a document management program causes a document management apparatus having processing executing section which executes a processing to document data registered in a folder in accordance with a document processing constituted by one processing step or a plurality of processing steps allocated to the folder in advance to function as error-coping process storing section which stores a plurality of error-coping processes formed in advance, error-coping process setting section which presents list information of the plurality of error-coping processes and sets a selected error-coping process in a folder, and error-coping process executing section which executes the error-coping process in the folder set by the error-coping process setting section when an error occurs in the execution of the document processing by the processing executing section.

### BRIEF DESCRIPTION OF THE DRAWINGS

FIG. 1 is an entire block diagram showing a main configuration of a document management system according to an embodiment;

FIG. 2 is a block diagram showing an internal configuration and functions of a document management apparatus according to the embodiment;

FIG. 3 is a functional block diagram showing functions held by a procedure automatic executing function of the embodiment;

FIG. 4 is a diagram explaining a relationship among an automatic document processing, processing steps, and an error-coping process in the embodiment;

FIG. 5 is a flow chart showing a setting operation of the automatic document processing according to the embodiment;

FIG. 6 is a flow chart showing a setting operation of the error-coping process according to the embodiment;

FIG. 7 is a diagram showing an example of a display screen according the embodiment;

FIG. 8 is a diagram showing another example of display screen according to the embodiment;

FIG. 9 is a diagram showing still another example of display screen according to the embodiment;

FIG. 10 is a diagram showing still another example of display screen according to the embodiment;

FIG. 11 is a diagram showing still another display screen according to the embodiment;

FIG. 12 is a diagram showing still another example of display screen according to the embodiment; and

FIG. 13 is a flow chart showing an executing operation of the error-coping process according to the embodiment.

### DESCRIPTION OF THE PREFERRED EMBODIMENTS

Embodiments of a document management apparatus, a document management method, and a document management program according to the present invention will be described below.

### (A) Embodiment

This embodiment explains a case in which the document management apparatus, the document management method, and the document management program according to the present invention are applied to a network obtained by connecting a terminal, a printer, a scanner, and the like through a communication line.

### (A-1) Configuration of Embodiment

FIG. 1 an entire block diagram showing a main configuration of a document management system according to the embodiment.

As shown in FIG. 1, a document management system 1 includes a document management apparatus 10, terminals 20-1 and 20-2, a printer 31, a scanner 32, a document storing unit 40, and the like. The terminals 20-1 and 20-2 are expressed as a terminal 20 when a common function of the terminal is explained.

In the embodiment, the constituent elements of the document management system 1 are connected to a communication line 50 to constitute a network. As a matter of course, the network can be extended such that the network is connected to another network to open the network through a repeater having a data converting function or the like.

The terminal 20 corresponds to, e.g., a personal computer or the like. The terminal 20 has a mail transmitting/receiving function to perform various designations and requests to the document management apparatus 10 by an operation of a user. The terminal 20-1 is a terminal operated by a user A, and the terminal 20-2 is a terminal operated by a user B.

The printer 31 receives printing data formed based on file data from the document management apparatus 10 by a designation of the document management apparatus 10, the terminal 20, or the like, and performs a printing operation based on the printing data.

The scanner 32 captures an image as a file by a designation of the document management apparatus 10, the terminal 20, or the like and gives the image to the document management apparatus 10 as image data to store the image data as a file.

In FIG. 1, the printer 31 and the scanner 32 are shown to clarify an input or output function of file contents in the system 1. As a matter of course, another image forming device or another image input device may be used. A composite device such as an MFP (Multi-Functional Peripheral) obtained by integrating these devices and functions may be used.

The document management apparatus 10 achieves a document registration function, a document management function, a file-edition management function, a procedure automatic executing function, and the document distributing function depending on various designations and requests received from the terminal 20 by a user operation. The document management apparatus 10 may realize only a mail function. The document management apparatus 10 may include a mail function or may use an external mail device without having a mail function. In the embodiment, the explanation will be performed on the assumption that the document management apparatus 10 has a mail function.

The right of access to the document management apparatus 10 is preset to only a user using the document management system 1. The user executes the access right to make it possible to access the document management apparatus 10.

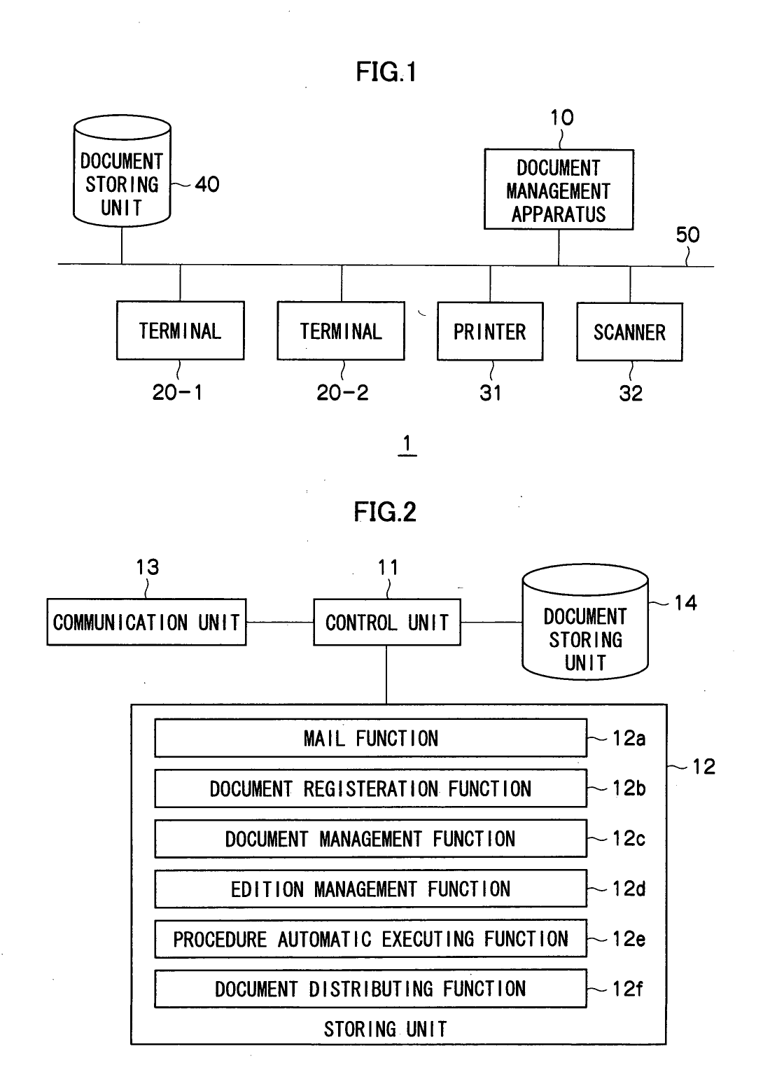

FIG. 2 is a block diagram showing an internal configuration and functions of the document management apparatus 10. As shown in FIG. 2, the document management apparatus 10 has a control unit 11, a storing unit 12, a communication unit 13, and a document storing unit 14.

The control unit 11 corresponds to, e.g., a CPU to control a function realized as the document management apparatus 10. The storing unit 12 corresponds to, e.g., a RAM, a ROM, or the like to store a processing program executed by the control unit 11, data required to execute the processing program, and the like. As main processing programs of the embodiment, a mail function 12a, a document registration function 12b, a document management function 12c, an edition management function 12d, a procedure automatic executing function 12e, and a document distributing function 12f are used. The control unit 11 can realize the functions by executing the processing programs in the storing unit 12. The processing programs executed by the document management apparatus 10 may be stored in a computer readable recording medium and read and executed by a computer.

The communication unit 13 is to realize a communication process by a predetermined communication method under the control of the control unit 11. The document storing unit 14 is to store a registered file and corresponds to an external storing device or the like. The document storing unit 14 may not be physically arranged in the same apparatus when the document storing unit 14 can be controlled by the control unit 11.

Functions realized by the document management apparatus 10 will be described below. As described above, the functions realized by the document management apparatus 10 are realized such that the control unit 11 executes the processing programs in the storing unit 12.

The mail function 12a is a function which transmits or receives an electronic mail to/from a computer apparatus having a mail function and connected to the communication line 50. The document management apparatus 10 uses the mail function 12a to make it possible to receive a designation or a request from the terminal 20 to transmit or receive an electronic mail added with a file.

The document registration function 12b is to receives a registration designation (for example, a designation by an electronic mail) from the terminal 20 to register and store the designated file in a designated folder. The document registration function 12b receives a designation from the terminal 20 and can newly form a folder if necessary. In registration of a file, for example, a file added to an electronic mail may be handled as a file to be registered, or a designated file may be acquired from the document storing unit 40 and registered by tracing the address of the designated document storing unit 40 when registration is designated from the terminal 20.

The document management function 12c is a function which manages registered files in units of folders. The document management function 12c manages folder attribute information of a folder as one of pieces of document management information to be managed. As the folder attributes, for example, a folder name, an owner of the folder, a forming data, an updating data, ON/OFF information of a setting of the automatic document processing, automatic document processing identification information (ID) for identifying the set automatic document processing, and the like are managed. The document management function 12c can manage not only folders uniquely allocated to users but also shared folders shared by a plurality of users. The shared folders may be shared by all users, shared by a plurality of specific users, or divided depending on types of file contents (for example, job contents). The document management function 12c may set a user who can access a shared folder and only allow the specific user to access the folder. Furthermore, when the document management function 12c functions as a shred document management function, for example, control of accesses from a plurality of users to the same document, i.e., a contention avoiding function, can be achieved.

When a stored file is checked out, edited on a user side, and changed in file content, the edition management function 12d manages the edition of the file. The edition management function 12d according to the embodiment may intend to manage the number of times of updating of the file changed in content, to mange the number of times of check out action made by each file or to manage the number of times of using of a user who requests a check-out operation, a use date, and the like.

The procedure automatic executing function 12e is designed to set an automatic document processing which automatically execute a predetermined processing to a folder in response to a designation from the terminal 20 by a user operation. When a file is registered in a folder to which an automatic document processing is allocated, a processing to the file is automatically executed in accordance with the set automatic document processing. The procedure automatic executing function 12e can set an error-coping process to the set automatic document processing, or one processing step or a plurality of processing steps constituting the set automatic document processing.

In this case, the automatic document processing can be set through the terminal 20 by an intention of a user. For example, the automatic document processing includes processing steps of copying or moving a document or a folder, sending a file by a facsimile or an e-mail to a designated address, sending file data to a designated printer, converting the format of file data into a designated format, and converting the file data into text data by using an OCR or the like. The automatic document processing may be constituted by one processing step selected from the processing steps or may be constituted by a combination of the plurality of processing steps.

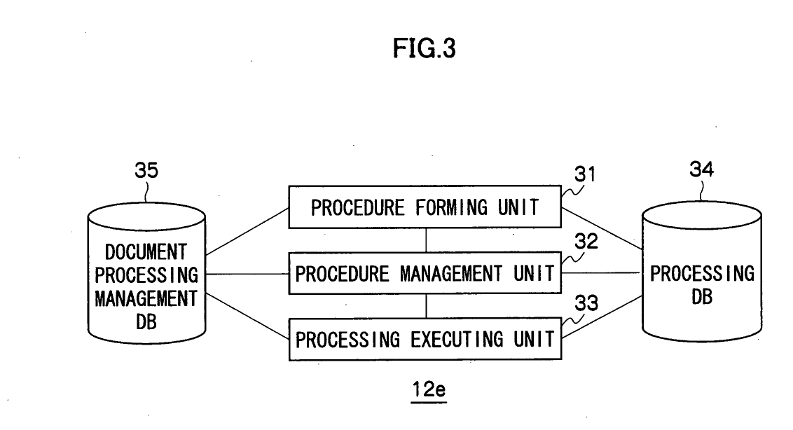

FIG. 3 is a functional block diagram for more exactly explaining the internal function of the procedure automatic executing function 12e. As shown FIG. 3, the procedure automatic executing function 12e has a procedure forming unit 31, a procedure management unit 32, a processing executing unit 33, a processing database (DB) 34, and a document processing management database (DB) 35.

The procedure forming unit 31 allocates an automatic document processing set by a user to a folder. When the procedure forming unit 31 receives a setting request of the automatic document processing from the user terminal 20, the procedure forming unit 31 gives processing step list information constituted by a plurality of preset processing steps to the user terminal 20 and allocates a selected one processing step or a plurality of selected processing steps to a folder as the automatic document processing.

In this case, the processing steps are added with identification numbers to identify the processing steps and registered in the processing database (DB) 34. When a user selects a processing step and determines the processing step as the automatic document processing, the procedure forming unit 31 forms the selected one processing step or the plurality of selected processing steps as the automatic document processing, issues identification information representing the overall automatic document processing (automatic document processing ID), and includes the automatic document processing ID as one of pieces of attribute information of the folder.

The procedure forming unit 31 is designed to allocates an error-coping process of the automatic document processing allocated to the folder. When the procedure forming unit 31 receives a setting request of the error-coping process from the user terminal 20, the procedure forming unit 31 gives list information of the preset error-coping process to the user terminal 20, and allocates the selected error-coping process to each processing step of the automatic document processing and/or the overall automatic document processing of the folder.

The error-coping processes are added with identification numbers in advance to identify the error-coping processes and registered in the processing DB 34. The user selects the error-coping processes for the overall automatic document processing and/or the processing steps, respectively, and causes the selected error-coping processes to correspond to the overall automatic document processing or the processing steps, respectively.

The procedure management unit 32 is designed to store and manage the automatic document processing formed by the procedure forming unit 31 in the document processing management DB 35. If the automatic document processing allocated to the folder can be managed, the automatic document processing may be stored in the document storing unit 14.

When a file is registered in a folder to which the automatic document processing is allocated, the processing executing unit 33 executes a processing step set for the file. When an error occurs in the processing step to be executed, the processing executing unit 33 executes an error-coping process allocated to the processing step or the overall automatic document processing.

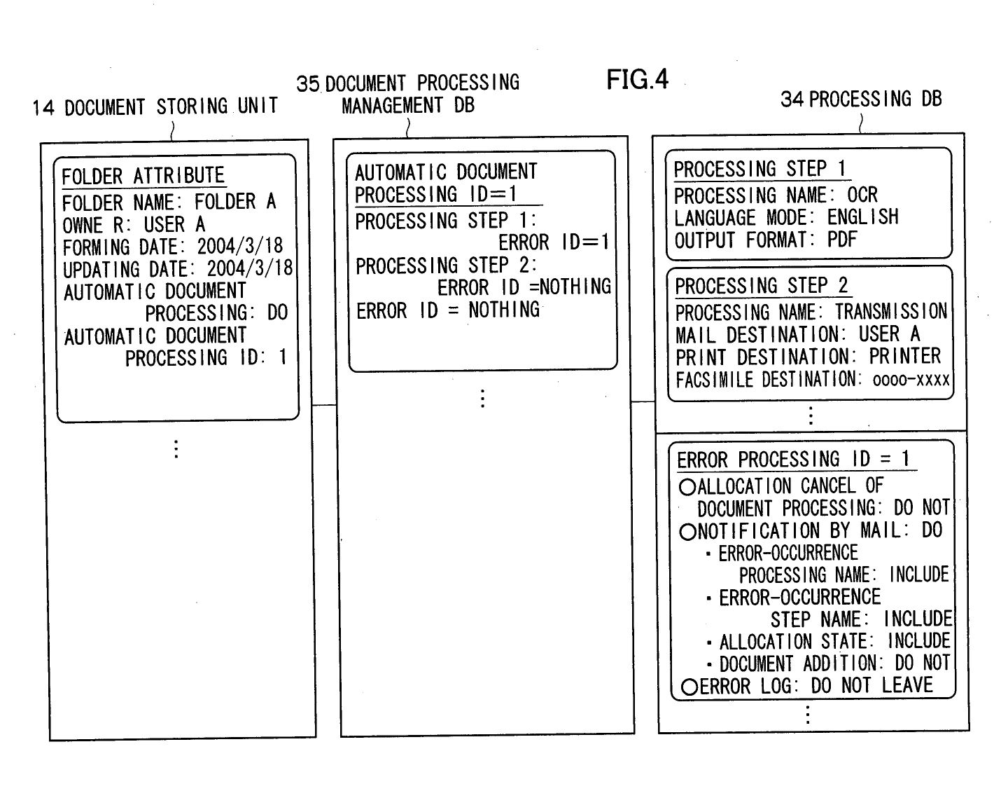

FIG. 4 is a diagram for explaining a relationship among the automatic document processing, the processing step, and the error-coping process. As shown in FIG. 4, attribute information of a folder is stored in the document storing unit 14. The automatic document processing is stored in the document processing management DB 35. Furthermore, the processing step and the error-coping process are stored in the processing DB 34.

When a file is registered in a folder, the processing executing unit 33 detects the attribute information of the folder from the document storing unit 14 and detects the automatic document processing based on the automatic document processing ID of the folder attribute information. A processing step included in the detected automatic document processing is detected from the processing DB 34 based on the processing step ID, so that the processing executing unit 33 can execute the processing step.

When an error occurs in the processing step, and when an error-coping process is allocated to the processing step in which the error occurs, the processing executing unit 33 executes the error-coping process. When the error-coping process is not allocated to the processing step in which an error occurs, the error-coping process allocated to the overall automatic document processing can be executed.

Returning to FIG. 2, the document distributing function 12f is a function which distributes a designated file as an electronic mail to the plurality of terminals 20 in response to a designation from the terminals 20 or distributes the designated file to the plurality of designated printers 31 or the like and causes the printers 31 or the like to output the file.

### (A-2) Operation of Embodiment

An operation of the document management apparatus 10 according to the embodiment will be described below with reference to the accompanying drawings. A setting operation of the automatic document processing and a setting operation of the error-coping process will be described below.

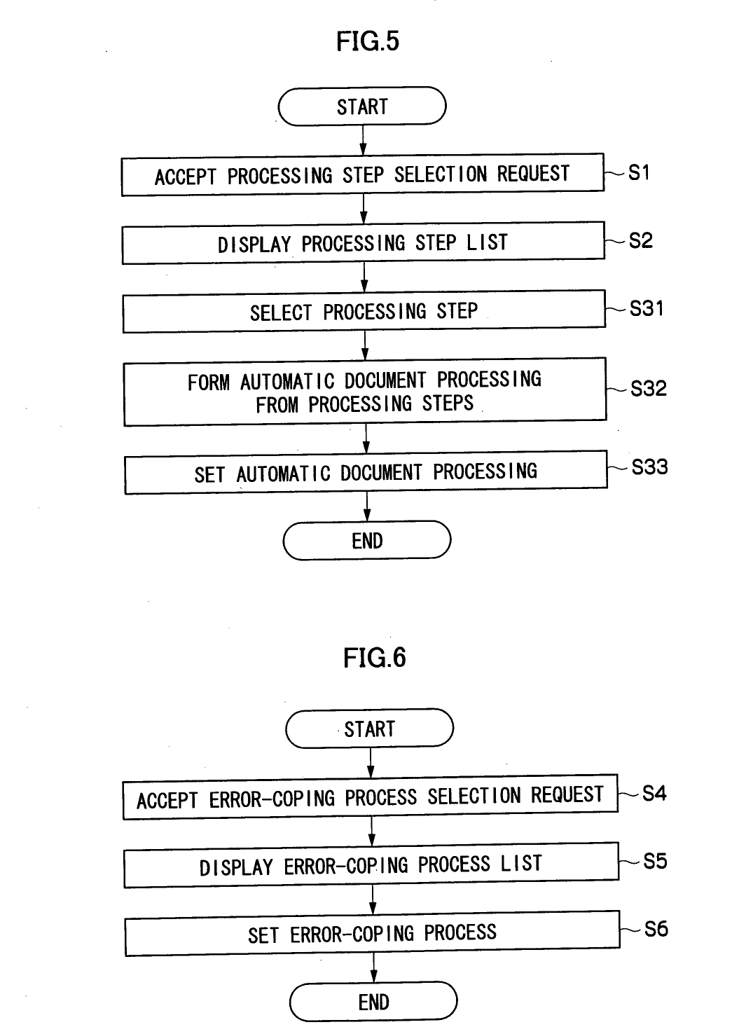

FIG. 5 is a flow chart of a setting operation of a processing step of a folder in the document management apparatus 10. FIG. 6 is a flow chart of a setting operation of an error-coping process of a processing step of the folder in the document management apparatus 10.

In FIG. 5, by a user operation, a processing step selection request from the terminal 20 is given to the document management apparatus 10 (S1), and list information of processing steps registered in the processing DB 34 in advance is given to the terminal 20 (S2).

When the list information of the processing steps is given to the terminal 20, the user selects information from the displayed processing step list information, and the selected information is given from the terminal 20 to the document management apparatus 10 (S31).

In the document management apparatus 10, an automatic document processing is formed based on the plurality of processing steps selected by the user (S32). The identification information of the issued automatic document processing is included in the folder, and the automatic document processing constituted by a plurality of processing steps is set in the document processing management DB 35 (S32).

A setting operation of an error-coping process will be described below with reference to FIG. 6. In FIG. 6, when a selection request of the error-coping process is given by a user operation from the terminal 20 to the document management apparatus 10 (S4), an error-coping process list registered in the processing DB 34 in advance is given to the terminal 20 (S5).

When the error-coping process is given to the terminal 20, the information of an error-coping process selected by the user is given from the terminal 20 to the document management apparatus 10. In the document management apparatus 10, the identification information of the error-coping process selected by the user is set in association with a processing step designated by the user (S6).

The selection of the error-coping process can be performed to each of the processing steps or the overall automatic document processing allocated to a folder.

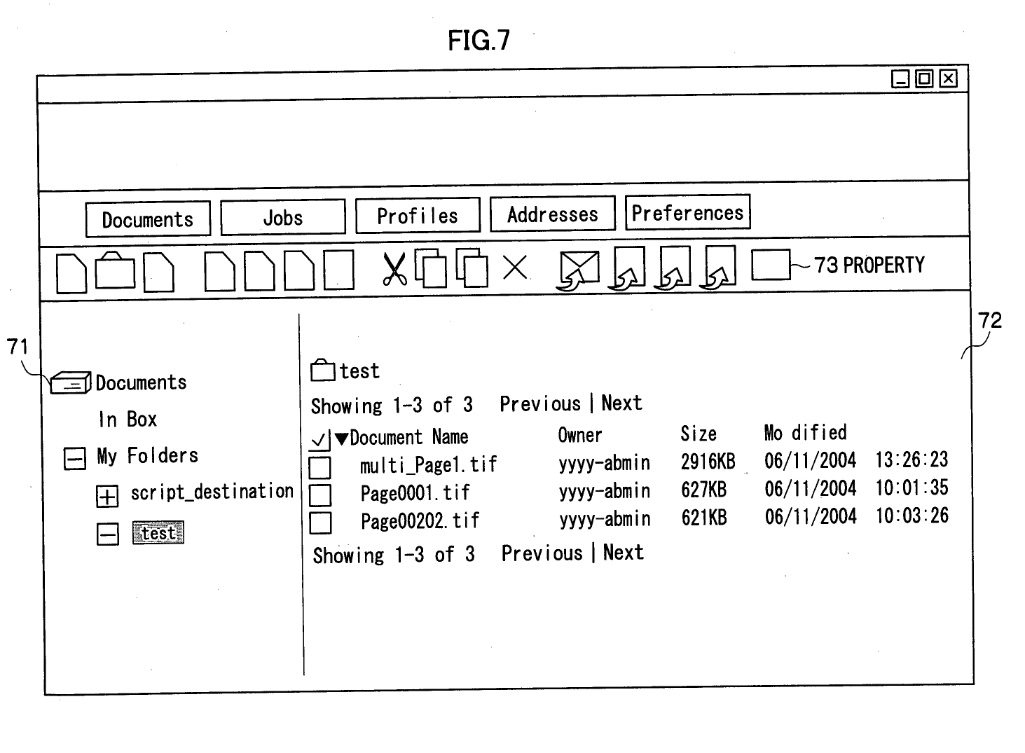

Setting operations of the automatic document processing and the error-coping process will be described below with reference to display screens of the terminal 20. FIGS. 7 to 12 show display screens, respectively.

FIG. 7 shows a screen for checking a registration status of a folder in a log-in state. FIG. 7 shows Documents page of a plurality of pages.

In FIG. 7, a hierarchical level 71 of the folder and a content 72 of a holder having a name of “test” are displayed, and a case in which the test holder 72 stores three files therein. The folder content 72 displays a document name (Document Name) of a registered file, an owner (Owner) of the file, a size (Size) of the file, and an updating date (Modified).

A setting operation of the automatic document processing for the folder will be described below. In the embodiment, it is assumed that the automatic document processing is set based on the property of the folder.

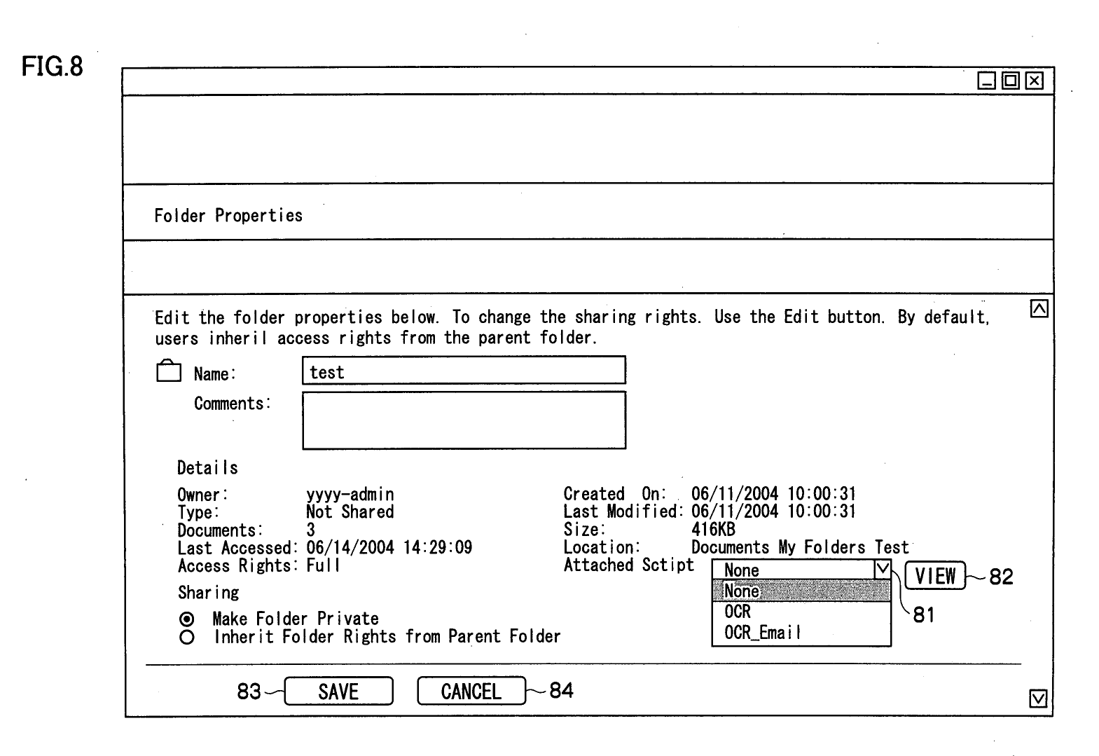

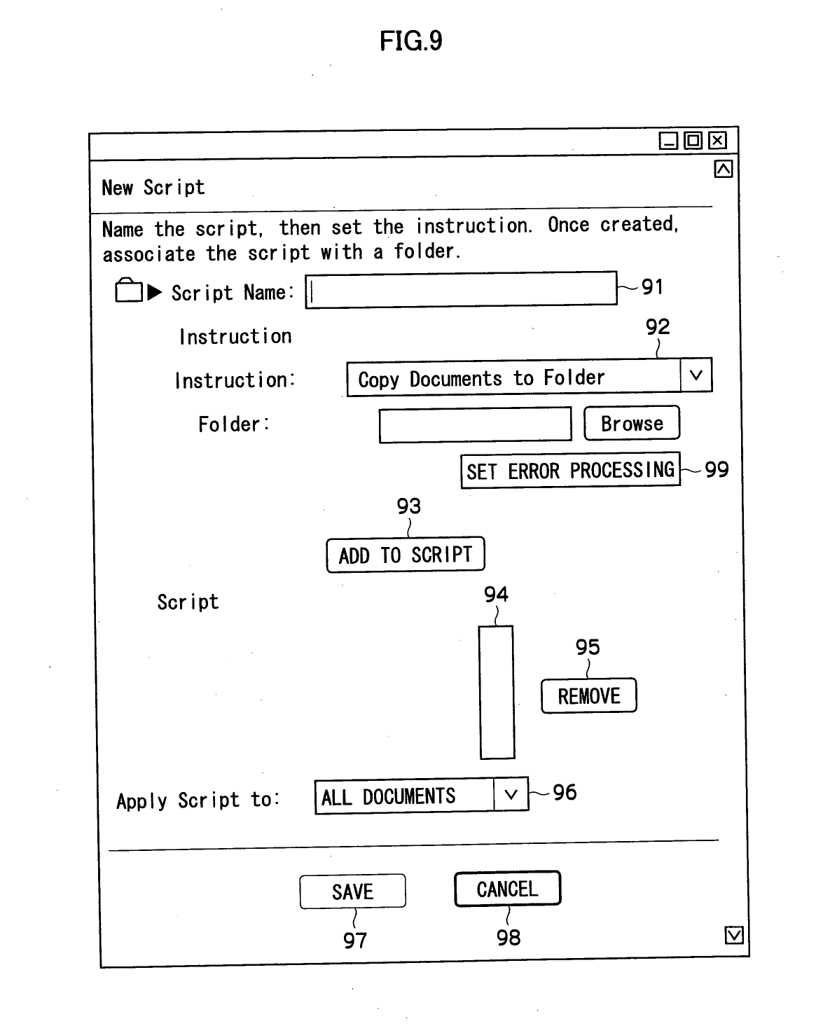

When a user depresses a property button 73 on the log-in screen in FIG. 7, a property screen of a folder shown in FIG. 8 is displayed.

In FIG. 8, the property screen includes a folder name, detailed information of a user of the holder, and, at least an automatic document processing list display unit 81, a setting button (View) 82 for setting the automatic document processing, a determination button (Save) button 83 for determining the set automatic document processing, a cancel button 84, and the like.

When a automatic document processing is newly set, a user depresses the View button 82. When the View button 82 is depressed, a setting screen shown in FIG. 9 is displayed.

When the user sets a new automatic document processing, the user inputs an automatic document processing name (Script Name). In this case, the input name corresponds to a name of an automatic document processing which can be displayed on the automatic document processing list display unit 81 in FIG. 8.

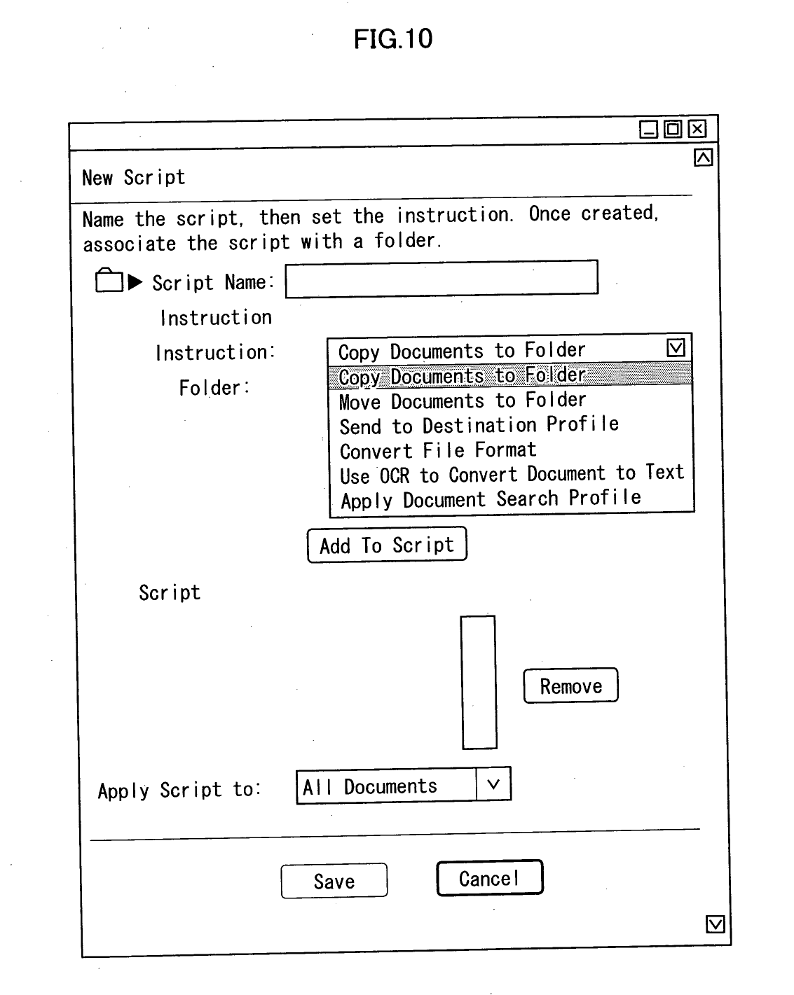

The user depresses a button 92 for a pull-down menu scheme, and, as shown in FIG. 10, list information of a plurality of processing steps is displayed. The list information of the plurality of processing steps is set in the processing DB 34 in advance.

Of the plurality of displayed processing steps, a processing step desired by the user is designated (for example, the designated processing step is inverted) and determined. For example, FIG. 10 shows a case in which the user selects “Copy Documents to Folder”. When this selection is made, a display is performed as shown in FIG. 9.

In this case, an “Add to Script” button 93 is depressed. For this reason, a processing step selected as a step of the automatic document processing is added, and the processing step is displayed in a field of “Script” to make it possible to select the processing step again. Similarly, a processing step can be selected from the list display in FIG. 10.

When the user depresses a “Save” button 97 to determine the automatic document processing.

In an application of the automatic document processing, the automatic document processing can be applied to each of files registered in a folder by selecting a type of an applied file by “Apply Script to”.

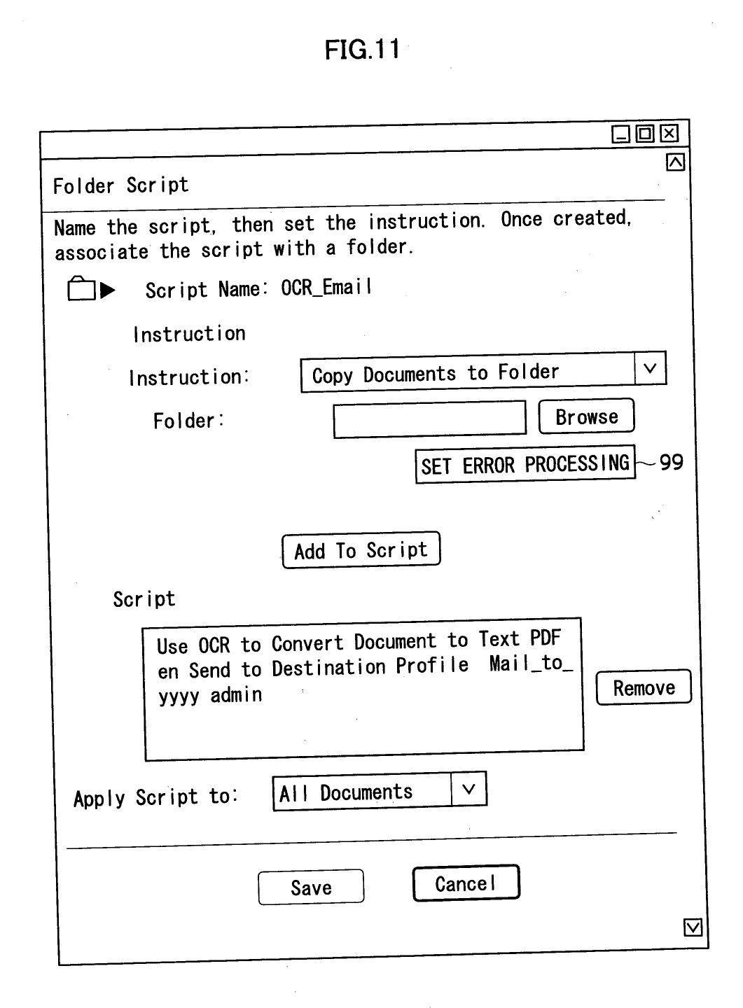

In this manner, the automatic document processing is set as shown in FIG. 11. FIG. 11 shows the following case. That is, the name of the automatic document processing is defined as OCR_Email, and, as processing steps are displayed to Script, two processing steps, i.e., “Use OCR to Convert Document to Text” and “Send to Destination Profile” are selected.

A setting operation of an error-coping process will be described below. In the embodiment, for example, it is assumed that the error-coping process is set from the setting screen of the processing steps in FIG. 9.

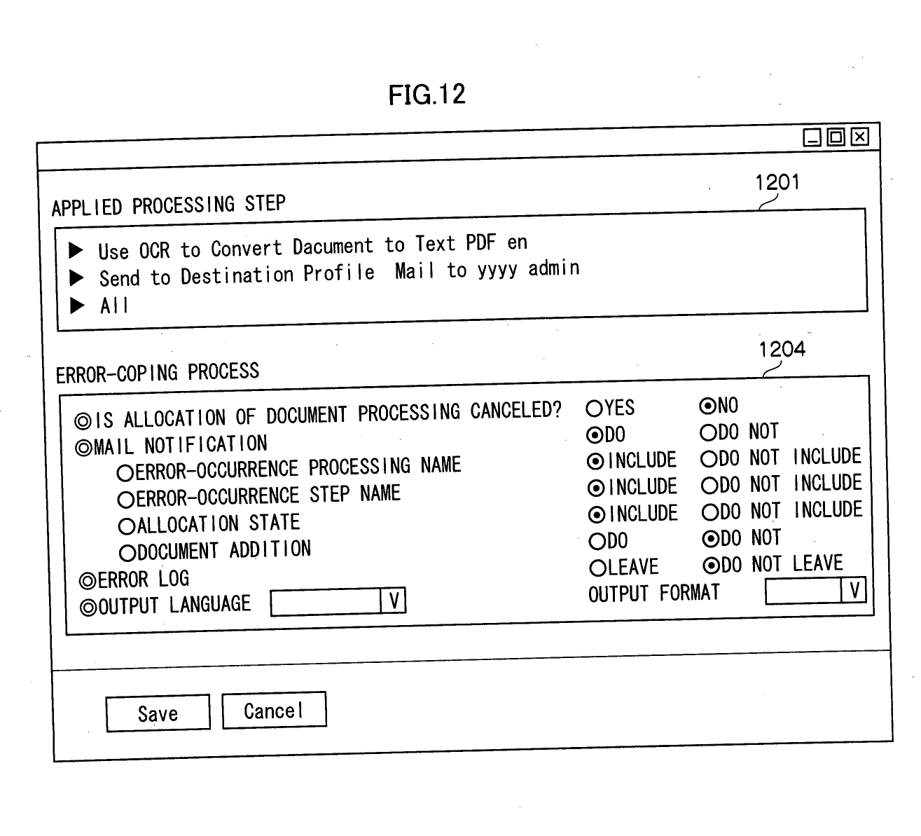

When the error-coping process is to be set, the user depresses the error processing setting button 99 in FIG. 9. In this manner, an error-coping process setting screen shown in FIG. 12 is displayed.

When the user selects a processing to be set in this time from the processing steps displayed in an applied processing step 1201, the selected processing is inversely displayed, and the set error processing content is automatically reflected on an error-coping process 1204 on a lower part of the screen. If any processing is not set, a value of a default error processing is set and displayed in the field of the error-coping process 1204. The processing step displayed as the applied processing is a processing step of the automatic document processing. For example, the processing step is a processing step displayed in a field of a Script 94 in FIG. 11. As shown in FIG. 12, the applied processing step 1201 includes “ALL” in which an error-coping process for the overall automatic document processing is performed. In selection of “ALL”, not only an error-coping process to each processing step but also an error-coping process to the overall automatic document processing can be set.

The user selects a desired error-coping process from the list of the displayed preset error-coping processes 1204.

In the selection of an error-coping process, for example, as shown in FIG. 12, preset parameters are displayed, and a parameter is selected from the displayed parameter.

As described above, when the user selects an error-coping process to determine the error-coping process, the user depresses a “Save” button to make it possible to set the error-coping process.

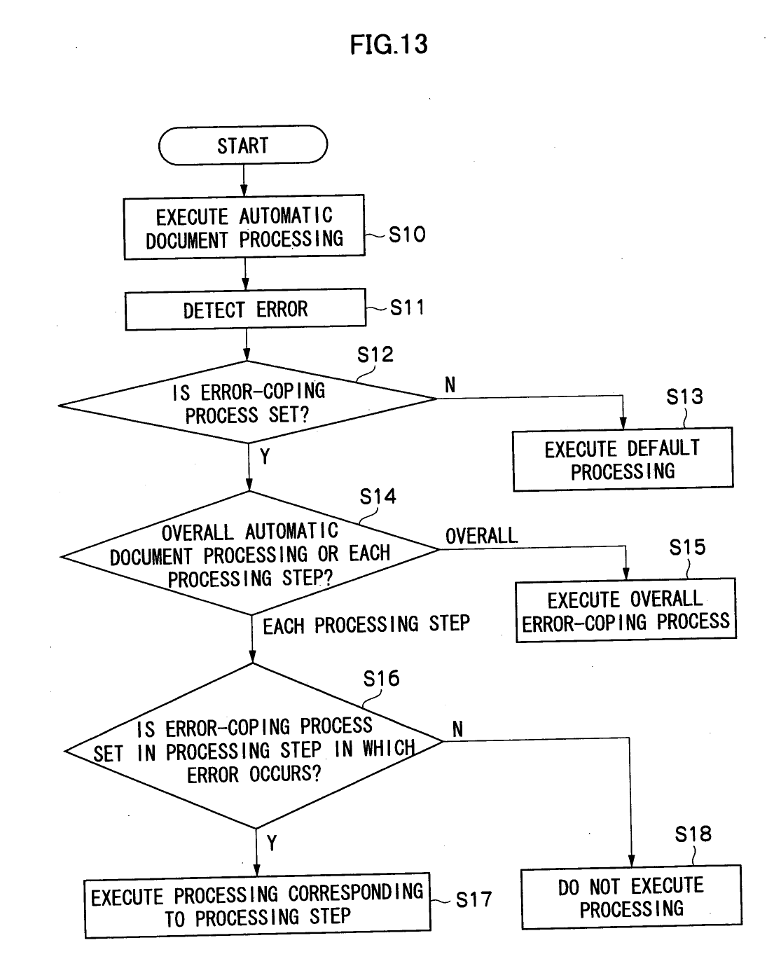

An operation of the document management apparatus 10 performed when an error occurs in the document processing will be described below. FIG. 13 is a flow chart showing the operation of the document management apparatus 10 in occurrence of the error.

When a file is registered in a folder in which an automatic document processing is set, the document management apparatus 10 executes a document processing to the file based on the set automatic document processing (S110).

When an error occurs in the processing step in execution of the document processing (S11), the document management apparatus 10 retrieves the setting content of the automatic document processing based on the automatic document processing ID of the folder in which the error occurs to determine whether an error-coping process is set in the folder or not based on the setting content of the automatic document processing (S12).

When an error-coping process is not set in the folder, the document management apparatus 10 executes a default process such that an error-coping process which is fixedly set in advance is performed or the error-coping process is not performed (S13).

On the other hand, an error-coping process is set in the folder, it is determined whether the set error-coping process is for the overall automatic document processing or for each of the processing steps (S14).

When the error-coping process is for the overall automatic document processing, the document management apparatus 10 execute the set error-coping process (S15).

The document management apparatus 10 determines whether or not an error-coping process is set in a processing step in which an error occurs (S16). When the error-coping process is set in the processing step in which the error occurs, an error-coping process corresponding to the processing step is executed (S17). When no error-coping process is set in the processing step in which the error occurs, an error-coping process is not executed (S18).

### (A-3) Effect of Embodiment

According to the above embodiment, an error-coping process can be set in each of processing steps constituting an automatic document processing by a simple operation. According to the embodiment, even though the level of importance of the processing step in which an error occurs is low in the automatic document processing, a partial error-coping process can be performed without stopping the overall automatic document processing.

### (B) Another Embodiment

(B-1) The above embodiment explains the case in which the present invention is applied to a closed network. However, the present invention can be widely applied to not only the closed network but also an open network.

(B-2) In FIG. 1, the constituent elements (the terminal 20, the printer 31, the scanner 32, and the like) may include a wireless communication device which uses a predetermined wireless scheme to perform wireless communication. The document management system 1 may communicate with a mobile communication terminal (for example, a mobile telephone, a PHS, or the like).

(B-3) Since the display screens shown in FIGS. 7 to 12 are examples, arrangements or layouts of the various buttons and the windows are not limited to specific arrangements or layouts.

(B-4) In the above embodiment, the explanation is performed on the assumption that an error-coping process can be set in the overall automatic document processing and/or each of the processing steps. However, for example, when an error-coping process is set in each of the processing steps, an error-coping process can be prevented from being set in the overall automatic document processing. For example, after an error-coping process is set in each of the processing steps, a setting portion for the overall automatic document processing is displayed in gray to prevent the error-coping process from being set in the overall automatic document processing.

(B-5) In the above explanation, when an error-coping process is set, the displayed selection screen of error-coping processes is explained as a selection list screen of preset error-coping processes. The error-coping processes are not limited to the error-coping process in the explanation, an error-coping process can also be selected from hierarchical error-coping processes.

What is claimed is:

1. A document management apparatus having processing executing section which executes a processing to document data registered in a folder in accordance with a document processing constituted by one processing step or a plurality of processing steps allocated to the folder in advance, comprising:
error-coping process storing section which stores a plurality of error-coping processes formed in advance;
error-coping process setting section which presents list information of the plurality of error-coping processes and sets a selected error-coping process in a folder; and
error-coping process executing section which executes the error-coping process in the folder set by the error-coping process setting section when an error occurs in the execution of the document processing by the processing executing section.

2. The document management apparatus according to claim 1, wherein
the error-coping process setting section presents a list of the error-coping processes in each of the processing steps constituting the document processing and respectively sets selected error-coping processes in the processing steps, and
the error-coping process executing section executes error-coping processes set in the processing steps in which errors occur.

3. The document management apparatus according to claim 1 or 2, wherein
the error-coping process setting section is prevented from performing an error setting to the overall document processing when the error-coping processes are set in the processing steps, respectively.

4. A document management method having processing executing section which executes a processing to document data registered in a folder in accordance with a document processing constituted by one processing step or a plurality of processing steps allocated to the folder in advance, wherein
error-coping process storing section stores a plurality of error-coping processes formed in advance,
error-coping process setting section presents list information of the plurality of error-coping processes and sets a selected error-coping process in a folder, and
error-coping process executing section executes the error-coping process in the folder set by the error-coping process setting section when an error occurs in the execution of the document processing by the processing executing section.

5. A document management program causing
a document management apparatus having processing executing section which executes a processing to document data registered in a folder in accordance with a document processing constituted by one processing step or a plurality of processing steps allocated to the folder in advance to function as
error-coping process storing section which stores a plurality of error-coping processes formed in advance,
error-coping process setting section which presents list information of the plurality of error-coping processes and sets a selected error-coping process in a folder, and
error-coping process executing section which executes the error-coping process in the folder set by the error-coping process setting section when an error occurs in the execution of the document processing by the processing executing section.
